(19) United States
(12) Patent Application Publication
(10) Pub. No.: US 2002/0069717 A1
(43) Pub. Date: Jun. 13, 2002

(54) Multi-cam constraint idler

(76) Inventors: Kevin J. Knox, Peoria, IL (US); Marvin P. Schneider, East Peoria, IL (US); Michael J. Smith, Dunlap, IL (US); Lloyd E. Thompson, Peoria, IL (US)

Correspondence Address: Robert J. Hampsch, Caterpillar Inc., Intellectual Property Department, AB6490, 100 N.E. Adams Street, Peoria, IL, 61629-6490, US

(21) Appl. No.: 09/732,526

(22) Filed: Dec. 7, 2000

(51) Int. Cl. F16H 55/18

(52) U.S. Cl. 74/409

(57) ABSTRACT

At least one redundant torque path between a driver and a first camshaft distributes dynamic torque applied to the first camshaft, allowing for cancellation of undesirable torque components. The second torque path includes a second camshaft and acts as a constraint on the first camshaft, ameliorating discontinuities in first camshaft rotation due to sudden changes in load on the first camshaft.

### TECHNICAL FIELD

This invention relates generally to engines, and more particularly to gear trains in engines for driving mechanically actuated fuel injectors.

### BACKGROUND ART

Diesel engines are required to meet ever-reducing emission levels. Increasing the pressure to spray the fuel into the cylinders is one method of reducing emissions. Increased injection pressure requires additional torque to drive the injection system. The increased drive torque caused by high injection pressures in the unit injector fuel systems causes high-load gear impacts that generate considerable noise and occasionally mechanical failure of the gears.

For example, typically fuel pressurization in a mechanically actuated fuel injector is achieved by downward pressure on a plunger in the fuel injector. A cam operates an arm to push down on the plunger. The cam is driven by a driver gear or a driver idler gear engaged with and rotating a cam gear. While the cam is pushing against the arm to pressurize fuel tremendous force is being applied by the driver or driver idler gear against the cam gear.

When the fuel injector releases the pressurized fuel the pressure on the plunger is suddenly eliminated. With the suddenly cessation of return force from the cam gear against the driver gear, the cam gear may be propelled violently forward so that the cam gear teeth can fly off the driver gear teeth and actually slam into the respective driver gear teeth in front of them. This causes considerable noise, and also contributes to gear wear.

Further, gear train strength has been increased with a change from helical gears to high contact ratio spur gears. Accordingly, the width of the gears has been increased. With every increase in injection pressure the gear loads and noise tend to increase. Accordingly it has become difficult to provide acceptable mechanical reliability with a low noise level in these gear trains with the increase in injection pressure. Larger and stronger gears, when used, cause dynamic problems of their own with their significantly increased inertia. A solution is needed to reduce the impact loads in these gear trains and otherwise address these problems.

Various techniques, including the use of torsional (viscous or rubber) dampers, absorbers, split or scissors gears, and gear backlash control techniques, have been tried. For example, U.S. Pat. No. 5,272,937 teaches an active inertia torque absorber.

These techniques have some problems. For example, the absorber and damper strategies either absorb and return the dynamic energy, or dissipate it as heat. Both of these devices have limited capacity for reducing torque. Furthermore, the added inertia of their mechanisms can increase the dynamic input. Additionally, their size can increase the weight and volume of the engine, which affects packaging and fuel economy.

Backlash control techniques with split or scissors gears can reduce the impact loads, but require a spring to force the two gears to opposite sides of the mesh. The spring in the split gear must be strong enough to be effective, yet not so forceful as to add excessive friction to the system. The split gear spring can be optimized at only one operating condition. The split gear technique requires additional axial length for packaging. Designing and producing a split gear backlash limiting system is difficult, and therefore expensive.

### DISCLOSURE OF THE INVENTION

In a first aspect of the invention, a gear arrangement in an engine has first and second cams and a driver capable of rotatably driving the first and second cams. A first mechanical connection between the first cam and the second cam includes the driver. A second mechanical connection between the first cam and the second cam does not include the driver and substantially constrains the rotational motion of the first cam to the rotational motion of the second cam.

In a second aspect of the invention, a gear train in an engine comprises a first gear mounted on a first camshaft, a second gear mounted on a second camshaft, a driver, and a constraint idler gear. The driver includes one of a driver gear and a driver idler gear and is mechanically connected with the first gear and the second gear in a first mechanical path between the first gear and the second gear for causing coordinated rotation of the first gear and the second gear. The constraint idler gear is mechanically connected with the first gear and the second gear in a second mechanical path between the first gear and the second gear different from the first mechanical path and not including the driver. Rotation of the first gear and rotation of the second gear are mutually constrained via the constraint idler gear.

In a third aspect of the invention, a method for regulating motion of a first cam in an engine comprises providing a driver mechanically connected with the first cam via a first torque path to provide a motive force for rotating the cam, and providing a second torque path, distinct from the first torque path, between the driver and the first cam, such that rotational torque from the driver is applied to the first cam at first and second respective locations on the first cam. The second torque path includes a second cam, not in the first torque path, that transmits torque from the driver to the first cam. The second torque path provides a constraint on the first cam to check a sudden change in rotation speed of the first cam due to a sudden change in load on the first cam.

### BRIEF DESCRIPTION OF THE DRAWINGS

The invention is described herein with reference to the drawing of embodiments of the invention, in which:

FIG. 1 is a representational drawing of a drive train configuration according to a first embodiment of the invention;

FIG. 2 is a representational drawing of a drive train configuration according to a second embodiment of the invention;

FIG. 3 is a representational drawing of a drive train configuration according to a third embodiment of the invention;

FIG. 4 is a representational drawing of a drive train configuration according to a fourth embodiment of the invention;

FIG. 5 is a representational drawing of a cam and fuel injector configuration adaptable to the invention;

FIG. 6 is a representational drawing of a box-gear configuration adaptable to various embodiments of the invention; and

FIG. 7 is a representational drawing of a drive train configuration to according to yet another embodiment of the invention.

### BEST MODE FOR CARRYING OUT THE INVENTION

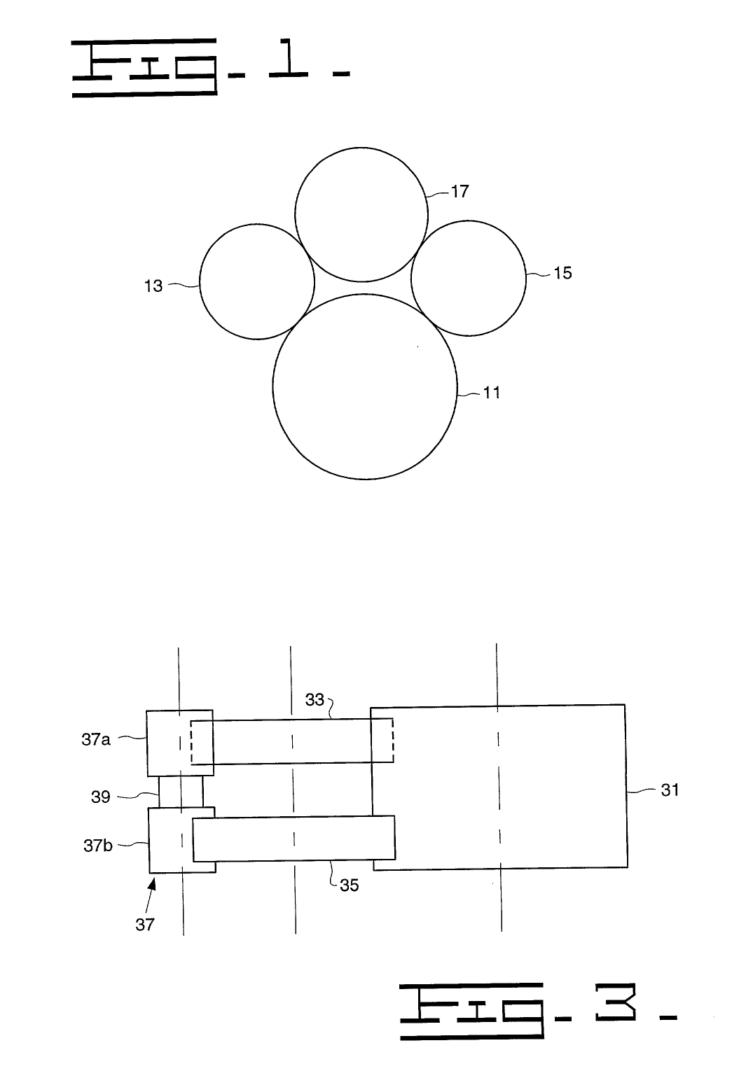

With reference to FIG. 1, in a first embodiment of the invention a drive idler 11 engaged by a drive gear (not shown) engages both a first cam 13 and a second cam 15. (Alternatively, the drive gear could engage the first cam 13 and second cam 15 directly.) A constraint idler 17 engages both the first cam 13 and the second cam 15.

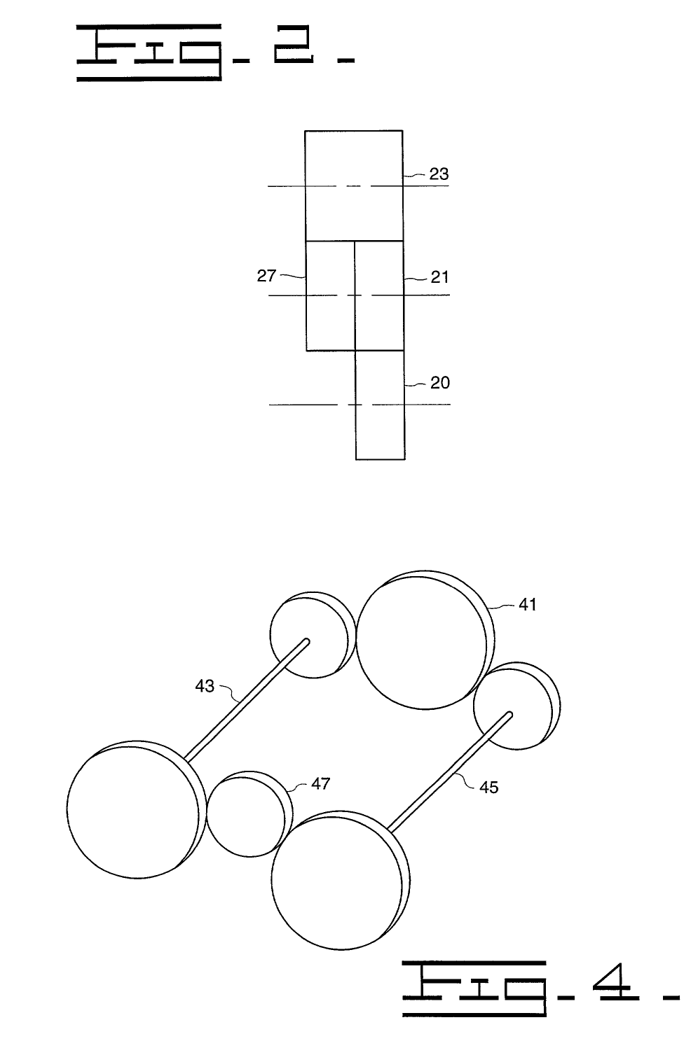

With reference to FIG. 2, in a second, more compact or “folded” embodiment of the invention, a drive gear 20 engages a drive idler 21. The drive idler engages both a first cam 23 and a second cam (not shown, located behind the first cam 23). A constraint idler 27 engages both the first cam 23 and the second cam.

With reference to FIG. 3, in a third, split gear embodiment of the invention, a drive idler 31 engaged by a drive gear (not shown) engages both a first cam 33 and a second cam 35. (Alternatively, the drive gear could engage the first cam 33 and the second cam 35 directly.) A split gear constraint idler 37 engages both the first cam 33 and the second cam 35.

A first half 37a of the split gear constraint idler 37 engages the first cam 33, while a second half 37b of the split gear constraint idler 37 engages the second cam 35. The two halves of the split gear constraint idler 37 are connected by a torsion member 39 that allows a small, predetermined variation in rotational position between the two halves, while providing a torsional force biasing the two halves to the same rotational position.

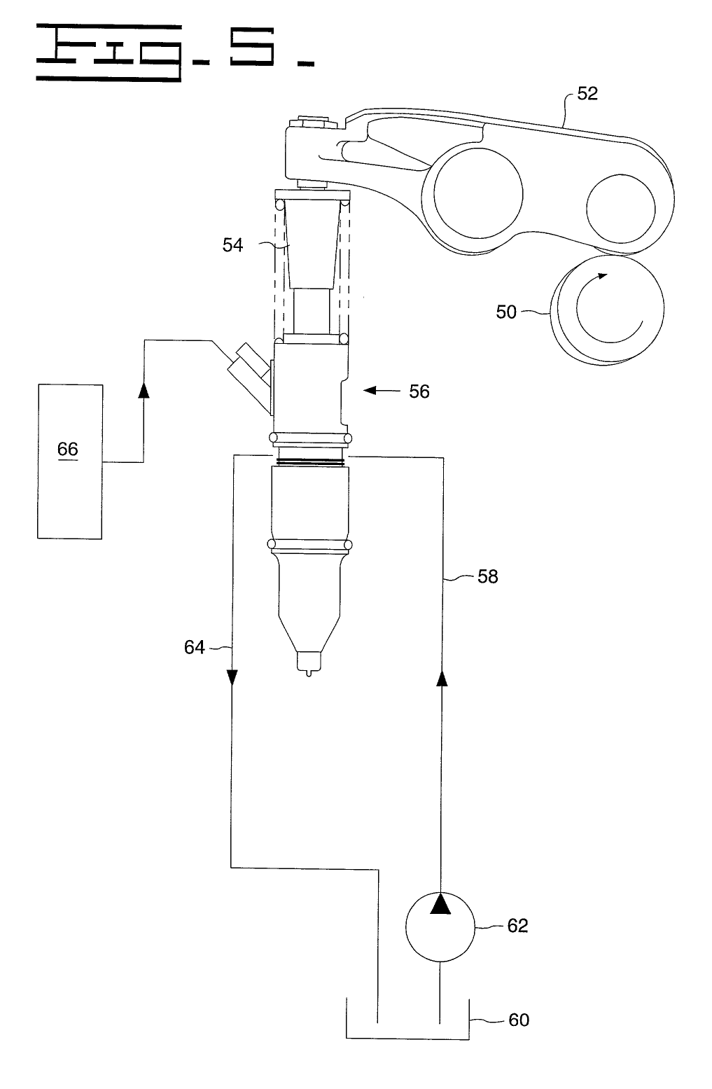

With reference to FIG. 4, in a fourth, plural-plane embodiment of the invention, a driver or drive idler 41 engages both a first gear portion of a first cam 43 and first gear portion of a second cam 45. A constraint idler 47 engages both a second gear portion of the first cam 43 and a second gear portion of the second cam 45.

With reference to FIG. 5, a cam 50 engages a pivot arm 52 disposed to push down on a plunger 54 of a fuel injector 56. The cam 50 and/or a similar cam could represent, for example, one or both of the cams 13, 15, 23, 25, 33, 35, 43, 45 of any of the above embodiments. A fuel supply passage 58 fluidly connects a fuel tank 60 with the fuel injector 56 via a fuel transfer pump 62. A fuel drain passage 64 fluidly connects the fuel injector 56 with the fuel tank 60. An electronic control module 66 can control fuel injection timing and other variables for operating the fuel injector 56.

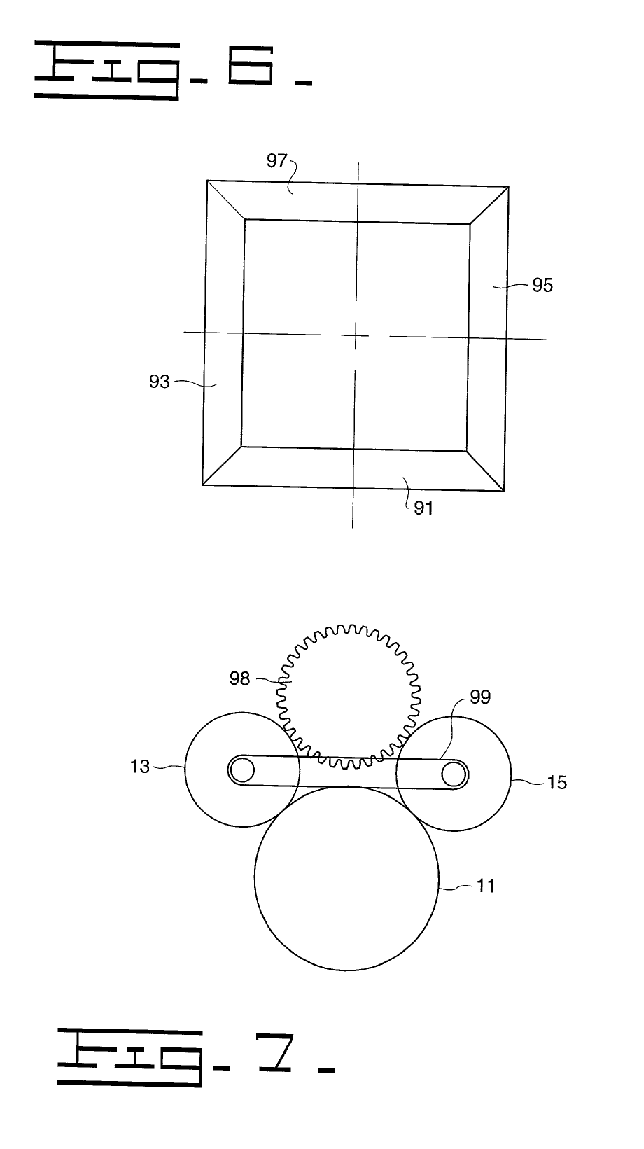

FIG. 6 shows an example possible “box gear” configuration for various embodiments of the invention. For example, a driver or drive idler 91 can engage a first cam 93 and a second cam 95, which in turn both engage a constraint idler 97.

FIG. 7 shows an alternate embodiment of the invention similar to the first embodiment, wherein the constraint idler or constraint idler gear includes a toothed gear 98 in addition to a friction belt or sprocket-driven belt or chain 99. In other embodiments (not shown) the friction belt or sprocket-driven belt or chain 99 could be used in place of the toothed gear 98, instead of merely in addition to it.

### Industrial Applicability

The illustrated embodiments modify a gear train by adding more than one torque path from the source of the dynamic load to a cam. This has the effect of distributing the dynamic torque, and allows for cancellation of that torque. This is especially true when a second cam is in one of the separate torque paths to the cam affected. The second cam has a load and usually a significant inertia of its own, and so acts to help constrain backlash motion of the affected cam.

With reference to FIG. 5, fuel from the fuel tank 60 is generally pumped into the fuel injector 56 via the fuel supply passage 58 by the low-pressure fuel transfer pump 62. As the cam 50 rotates, a projection on the cam 50 pushes one end of the pivot arm 52 upward. This causes the other end of the pivot arm 52 to push downward on the plunger 54. This pressurizes the fuel in the fuel injector 56. Because of the great pressures needed for high pressure fuel injection, the force provided by the cam 50 to push the plunger 54 downward can be very great. In order to generate this force, a crankshaft must exert a very high level of torque on the cam 50, for example via a driver gear.

To start fuel injection, the electronic control module 66 releases the highly pressurized fuel in the fuel injector 56. This causes resistance to pushing the plunger 54 downward to effectively disappear, and the great force being applied to the cam 50 by the driver would cause the cam 50 to jump ahead if there were no other constraining force on the cam 50.

In gear train arrangements according to the invention such as in FIGS. 1-4, the driver 11, 21, 31, 41 is applying torque to rotate the first cam 13, 23, 33, 43, usually causing gear teeth on the driver 11, 21, 31, 41 to engage gear teeth on a gear of the first cam 13, 23, 33, 43. However, the driver 11, 21, 31, 41 is also applying torque to rotate the second cam 15, 25, 35, 45. This torque translates through the constraint idler 17, 27, 37, 47 to act on the first cam 13, 23, 33, 43 as well. The first cam 13, 23, 33, 43 and the second cam 15, 25, 35, 45 are generally operating a plurality of fuel injectors 56 with staggered injection times. Further, the injection timing of the fuel injectors 56 operated by the first cam 13, 23, 33, 43 is generally offset from the injection timing of the fuel injectors 56 operated by the second cam 15, 25, 35, 45.

As a result, when there is a sudden release of resistance against the first cam 13, 23, 33, 43 as described above, there is no simultaneous release of resistance against the second cam 15, 25, 35, 45, which has its own resistance of fuel injector 56 loads to contend with. Accordingly, the second cam 15, 25, 35, 45 provides a restraint on rotation of the first cam 13, 23, 33, 43 via the constraint idler 17, 27, 37, 47, tending to keep the first cam 13, 23, 33, 43 from jumping violently ahead.

Similarly, when there is a sudden release of resistance against the second cam 15, 25, 35, 45 because fuel injection commences from a fuel injector 56 operated by the second cam 15, 25, 35, 45 as described above, the first cam 13, 23, 33, 43 provides a restraint on rotation of the second cam 15, 25, 35, 45 via the constraint idler 17, 27, 37, 47, tending to keep the second cam 15, 25, 35, 45 from jumping violently ahead.

With reference to FIG. 3, by using a split gear constraint idler 37 a non-loaded torsion member 39 can provide some rotational leeway between the first half 37a of the constraint idler 37 constraining the first cam 33 and the second half 37b of the constraint idler 37 constraining the second cam 35. This may be useful in some configurations, depending on gear tolerance and other design parameters.

The constraint idler or constraint idler gear of the invention may typically be a toothed gear, but could also be (as illustrated in FIG. 7) a friction belt 99, a sprocket-driven belt 99, a sprocket-driven chain 99, or such, or a combination thereof used in conjunction with or in place of a toothed gear.

The invention is not limited to the disclosed embodiments. For example, one or more configurations of this invention disclosed herein have one driving gear, two driven gears, and one idler gear. The gears are on four separate parallel shafts, and are aligned in a single plane. The driving and driven gears are directly in contact. However, other embodiments of the invention include different numbers of driving, driven, and idler gears. Additional idler gears may separate the driving and driven gears. Further, the term “cam” used herein indicates a camshaft including gears and such mounted thereon that is loaded to drive a device.

The gears may be placed at various locations along their supporting shafts rather than aligned in one plane. The gear shafts may be aligned at various angles (as per bevel, worm, and crossed helical gears), and several gears may occupy a single shaft. The elements of the gear train may be divided among several gears. For example, the idler gear could be split into two gears separated by a flexible coupling in which one side contacts the driving gear and the other side contacts the driven gear.

Further, while in the illustrated in the embodiments the cams are used with fuel injectors, the invention may be practiced with cams that drive other mechanisms as well. For example, It is common practice to drive pumps, compressors, alternators, electric motors, etc. using the same gear train that drives a fuel injector. At least one of the recited cams could be “loaded” with other types of devices as well.

Accordingly, while the invention has been illustrated and described in detail in the drawings and foregoing description, such illustration and description are to be considered illustrative or exemplary and not restrictive; other variations to the disclosed embodiments can be made by those skilled in the art while practicing the claimed invention from a study of the drawings, the disclosure, and the appended claims.

1. A gear arrangement in an engine, comprising:
first and second cams;
a first mechanical connection between the first cam and the second cam, the first mechanical connection including a driver capable of rotatably driving the first and second cams; and
a second mechanical connection between the first cam and the second cam that does not include the driver and substantially constrains the rotational motion of the first cam to the rotational motion of the second cam.

2. The gear arrangement of claim 1, wherein the second mechanical connection between the first cam and the second cam includes at least one of a friction belt, a sprocket-driven belt, and a sprocket-driven chain.

3. The gear arrangement of claim 1, wherein the second mechanical connection between the first cam and the second cam includes a split gear.

4. The gear arrangement of claim 1, wherein the second mechanical connection between the first cam and the second cam includes a toothed gear.

5. The gear arrangement of claim 1, including a third mechanical connection between the first cam and the second cam that does not include the driver and substantially constrains the rotational motion of the first cam to the rotational motion of the second cam.

6. The gear arrangement of claim 5, wherein the third mechanical connection between the first cam and the second cam includes at least one of a friction belt, a sprocket-driven belt, and a sprocket-driven chain.

7. The gear arrangement of claim 5, wherein the third mechanical connection between the first cam and the second cam includes a split gear.

8. The gear arrangement of claim 5, wherein the third mechanical connection between the first cam and the second cam includes a toothed gear.

9. The gear arrangement of claim 5, wherein the second mechanical connection between the first cam and the second cam includes a toothed gear.

10. A gear train in an engine, comprising:
a first g ear mounted on a first camshaft;
a second gear mounted on a second camshaft;
a driver, including one of a driver gear and
a driver idler gear, mechanically connected with the first gear and the second gear in a first mechanical path between the first gear and the second gear, for causing coordinated rotation of the first gear and the second gear; and
a constraint idler gear mechanically connected with the first gear and the second gear, in a second mechanical path between the first gear and the second gear different from the first mechanical path and not including the driver, such that rotation of the first gear and rotation of the second gear are mutually constrained via the constraint idler gear.

11. The gear train of claim 10, wherein the second mechanical path essentially consists of the constraint idler gear.

12. The gear train of claim 10, wherein the second mechanical path does not comprise the driver.

13. The gear train of claim 10, wherein the constraint idler gear includes at least one of a friction belt, a sprocket-driven belt, and a sprocket-driven chain.

14. The gear train of claim 10, wherein the constraint idler gear is a split gear.

15. A method for regulating motion of a first cam in an engine, comprising:
providing a driver mechanically connected with the first cam via a first torque path to provide a motive force for rotating the cam; and
providing a second torque path, distinct from the first torque path, between the driver and the first cam, such that rotational torque from the driver is applied to the first cam at first and second respective locations on the first cam, the second torque path including a second cam, not in the first torque path, that transmits torque from the driver to the first cam,
such that said second torque path provides a constraint on the first cam to check a sudden change in rotation speed of the first cam due to a sudden change in load on the first cam.

16. The method of claim 15, wherein said first cam operates to provide pressurization of fuel in a fuel injector.

17. The method of claim 16, wherein said first cam operates to provide pressurization of fuel in a plurality of fuel injectors.

18. The method of claim 17, wherein said second cam operates to provide pressurization of fuel in a plurality of fuel injectors.

19. The method of claim 17, wherein said second cam operates to provide pressurization of fuel in a fuel injector.

20. The method of claim 16, wherein said second cam operates to provide pressurization of fuel in a fuel injector.
